(19) United States
(12) Patent Application Publication
(10) Pub. No.: US 2002/0124243 A1
(43) Pub. Date: Sep. 5, 2002

(54) Method of and program for updating software

(76) Inventors: Gerard Henricus Broeksteeg, Eindhoven (NL); Alphonsus Anthonius Jozef De Lange, Eindhoven (NL)

Correspondence Address: U.S. Philips Corporation, 580 White Plains Road, Tarrytown, NY, 10591, US

(21) Appl. No.: 10/017,944

(22) Filed: Dec. 7, 2001

(30) Foreign Application Priority Data
Dec. 13, 2000 (EP) 00204479.0

(51) Int. Cl. G06F 9/44

(52) U.S. Cl. 717/168

(57) ABSTRACT

A device (102) has software (116) that is arranged to operate at least partly under the control of configuration information (118). For updating the software by replacing an original part of the software by an updated part, the device comprises:

read means (122) for reading the configuration information,

conversion means (202) for converting the configuration information,

first storage means (204) for storing the converted configuration information, and,

second storage means (114) for storing the updated part of the software.

The invention relates to a method of updating software by replacing an original part of the software by an updated part, the software being arranged to operate at least partly under the control of configuration information.

The invention also relates to a computer program product arranged to make a processor execute the above method.

The invention also relates to a carrier comprising such a computer program product.

The invention also relates to a signal representing such a computer program product.

The invention also relates to a device comprising software and updating means for updating the software.

Nowadays, many functions of an apparatus are realized by means of software. Examples are a television, where video processing, sound processing and teletext services are realized by respective modules of software residing in the television, and a portable telephone, where basic functions like reception and conversion of the packages representing the audio and additional functions like maintaining a directory of names and numbers are all realized by software in the telephone. Also in more professional systems, like a medical system for acquiring and subsequently processing and presenting X-Ray images, many of the functions are realized by software. The software may reside in a ROM (Read Only Memory) of the apparatus or may be stored in a storage device of the apparatus, for example on a hard disk, from where it is loaded into the working memory when necessary. The software of the apparatus typically operates on data processed by the software. Such processing may involve some amendment of the data, for example, noise reduction of an image, or some conversion, for example a digital-to-audio conversion of digitally encoded sound. In other types of apparatus the data is the product generated by the apparatus when operated by a user, for example a word-processor producing a data file representing the created document. An apparatus often offers the user a certain flexibility as to how a specific function is exactly carried out. The software function delivered with the apparatus can be more or less adjusted or completed by the user. For example in a television, the default color settings may be altered and per program number the frequency and sometimes the name of the station can be entered. In a word processor the user may specify many settings like the default language, the default printer and the location of files. Such user preferences and system settings are usually called configuration information. The configuration information controls to a certain extent the behavior of the apparatus, that is, it specifies the functions of the apparatus. This is in contrast with data. The apparatus operates on the data, for example, processes it or produces it.

It is known to update the software in the above types of apparatus. The reasons for an update may be that the software contains an error and malfunctions in some situation or it may be intended to enhance a specific function of the apparatus or even to add a completely new function. The update may be a partial update, where a part of the software is replaced by a new part, or a complete update where all of the software is replaced by new software. If the software of the apparatus resides on a local storage device, the update comes down to replacing the software on that device. This means deleting the file or files with the old software from the storage medium and copying the file or files with the new software onto the storage device. However, the software in a ROM of an apparatus may also be updated. The apparatus then has a memory called EEPROM (Electrically Erasable Programmable Read Only Memory) or Flash ROM which can be erased and programmed to contain the updated software. In many cases updating the software comes down to deleting all the old software and copying the new software to either the storage device or into the EEPROM. Usually, in set-top boxes the software itself is stored in a Flash ROM, whereas the configuration data is stored in an EEPROM. A Flash ROM is non-volatile and can be erased on a sector-by-sector basis and re-programmed on a byte-by-byte basis. An EEPROM is also non-volatile and can be erased and re-programmed on a byte-by-byte basis.

The new software will have the same or similar functions as the earlier software. Therefore, the configuration information, containing the preferences and system settings set by the user, is needed again in the new version of the software. In the known systems, this need is satisfied by retaining the file, or other storage space, with the configuration information when new software is installed. This is realized simply by not deleting this configuration file when the files of the earlier software are deleted. Alternatively, the file is first copied to a safe place, for example a background storage device, then all files of the earlier software are deleted and the new files are brought in place. Finally, the configuration file is copied from the safe place to the location of the software which now contains the new software.

It is an object of the invention to provide a method as described in the preamble with improved handling of the configuration information. This object is achieved according to the invention by a method comprising: reading the configuration information, converting the configuration information, storing the converted configuration information, and storing the updated part. The conversion makes it possible for the configuration information entered for the earlier version of the software to be used as much as possible by the new version of the software, while this new version can be optimally designed and implemented so as to meet its own requirements. That is to say, the design and implementation of the new version need not take into account the way the configuration information was stored by the earlier version. The conversion process can take care of any differences between the structure and format of the configuration information in the earlier version and the structure and format of the configuration information in the new version. The invention realizes the advantage of design freedom for the new software while the configuration information entered earlier is still of use in the new release. This means that information like the preferences entered by the user of the earlier version can be used in the new version without the user having to enter them again. Thanks to the invention, there is no need for any user intervention for maintaining the configuration information when a new version of the software is installed. This allows a completely automatic, that is, without any user interaction, installation of new software. This is the more important for consumer apparatuses like a television where the user is typically not sufficiently skilled to install software and where it is not practically possible to send an engineer to each apparatus that needs to be updated.

A version of the method of updating software according to the invention is described in claim 2. It is advantageous to express the configuration information as a set of configuration parameters. In this way, a given aspect of the configuration information can be stored and retrieved as a dedicated parameter. An example is the default setting of the volume, which may be stored as a single parameter.

A further version of the method of updating software according to the invention is described in claim 3. These operations provide flexible ways of converting the configuration information to the new version. Copying a configuration parameter ensures that the original value is maintained for the new version, while the position of the parameter in the new set may be different from the original in order to fully adapt to the new version. Deleting a configuration parameter is of use when the new functionality does not need the corresponding configuration information any longer or when the configuration information is now stored in a different, potentially larger number of configuration parameters. Converting the configuration parameter allows the new software to store that type of configuration information in a different way, that is more conforming to its own needs. Simple examples are storing the configuration parameter in a different format, for example, now as an integer instead of as a byte or as a text of 10 bytes instead of as a text of 4 bytes; however, more complex changes, like a change from a one dimensional parameter to a two-dimensional parameter, are also possible. The operation of adding a new configuration parameter allows the new software to maintain configuration information about an aspect that was not available in the earlier software. The operation of adding a new configuration parameter may be arranged in such a way that it provides a default value for that parameter in the updated set.

A further version of the method of updating software according to the invention is described in claim 4. A conversion function is a convenient way to specify how a configuration parameter of the earlier software release is to be converted into a configuration parameter for the new software release.

Another version of the method of updating software according to the invention is described in claim 6. Using a conversion instruction that specifies how to convert the configuration information is a convenient way to achieve that this part of the software update does not require interaction by a user. This enables a fully automatic update of the software of an apparatus.

A further version yet of the method of updating software according to the invention is described in claim 8. Downloading the software from a remote location avoids the need to bring the software physically to the apparatus. An example is a television or a set-top box which are already connected to a cable or satellite antenna for the reception of the television programs. Such a cable (or satellite) signal may also be arranged to transport data and as such may be used to transport the software update from the remote location to the apparatus. The conversion instruction may also be transported in this way.

It is a further object of the invention to provide a device as described in the preamble with improved handling of the configuration information. This object is achieved according to the invention by means of a device wherein the updating means comprises: read means for reading the configuration information, conversion means for converting the configuration information, first storage means for storing the converted configuration information, and second storage means for storing the updated part. A device with such updating means is suitable for carrying out the method as described above, thereby achieving the described advantages.

The invention and its attendant advantages will be further elucidated with the aid of exemplary embodiments and the accompanying schematic drawings, wherein:

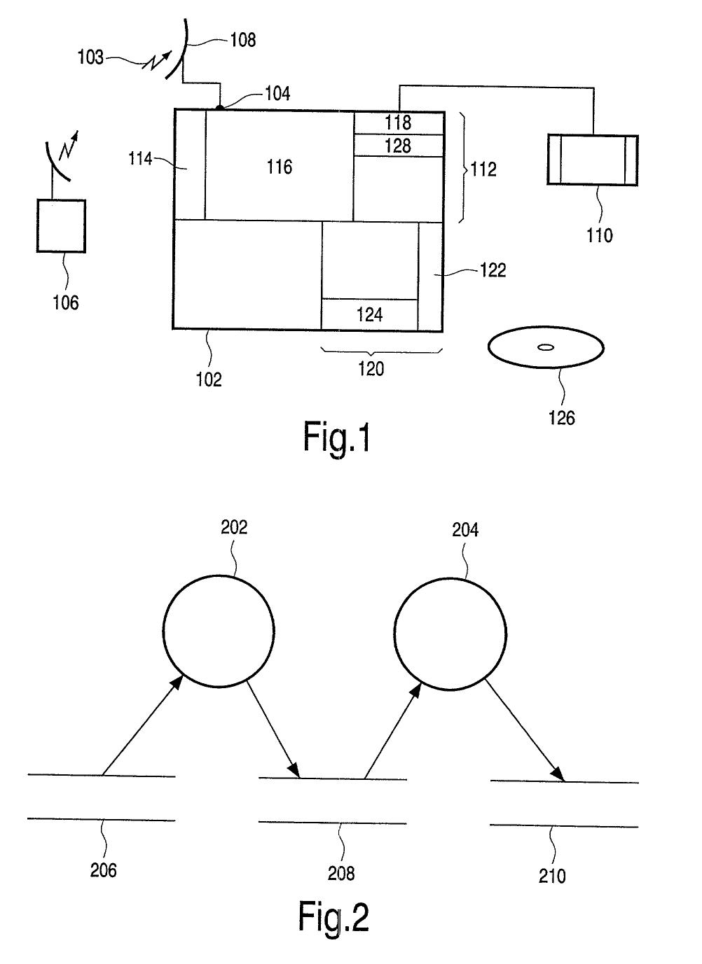

FIG. 1 schematically shows a device whose software is updated according to the invention,

FIG. 2 shows an overview of the conversion of the configuration information according to the invention, and

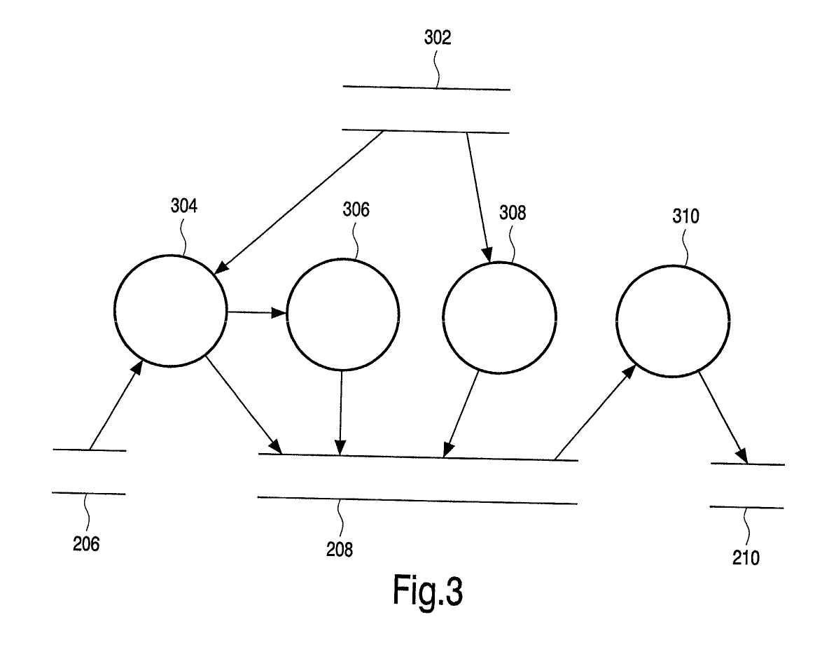

FIG. 3 shows the conversion of the configuration information according to the invention in more detail.

Corresponding features in the various Figures are denoted by the same references.

FIG. 1 schematically shows a device whose software is updated according to the invention. The device is a set-top box 102 which receives signals 103 representing television programs on an input 104. Apart from television programs, the signals may carry additional data, like Electronic Program Guide (EPG) or other information. The signals are transmitted by a provider 106 and received by an antenna 108 near the set-top box. Typically, the signals are transmitted to a satellite and then retransmitted to a plurality of receiver antennas. However, the nature of the transmission is not relevant for the invention and the set-top box could also be connected to a cable network transporting the signals from the provider. The signals are encoded according to a certain standard and the software of the set-top box decodes the signals and sends decoded signals to a television receiver 110 for reproduction. The audio/video signals of the television programs are typically encoded according to the MPEG standard. The structure of the set-top box and in particular the organization of some of the software parts will be discussed, hereinafter.

The set-top box has a permanent memory 112 in which the various software modules and other permanent data are stored. This memory is a Read Only Memory that can be programmed in parts when required and is implemented partially as an Electrically Erasable Programmable Read Only Memory (EEPROM) and partially as a Flash ROM. The memory 112 contains a loader module 114 that supports the downloads of new software on the set-top box. Furthermore, the memory contains the software modules implementing all functions of the box, like the decoding of the video stream. These software modules are symbolized by a single block 116 for clarity since their structure is not relevant to the invention. Furthermore, the memory 112 contains a file 118 containing configuration parameters of the software. These configuration parameters relate to various settings for the software, like the name, frequency, modulation and other information for each of the channels that can be received. The set-top box also has a memory 120 for the storage of data that are used and processed during the execution of the software and need not be stored permanently. This memory 120 is implemented as a Random Access Memory (RAM).

In addition to television programs, the provider 106 may, through signals 103, send software updates to the set-top box in a separate data layer which is available according to the transportation standard. The loader module 114 notices if such a software update stream is broadcast. The loader verifies whether the specific set-top box is entitled to receive the software updates and, if so, it commences the update procedure. The loader first selects a specific part of the software update stream, that is, a conversion module 122, and loads this part into the working memory 120. After that, the loader activates the read component of this conversion module. The conversion module reads the configuration file 118 and stores it in the storage space 124 of the working memory 122. The conversion module has a script in the form of a table specifying whether part of the configuration file need be converted. The conversion is executed prior to storing the configuration information in the working memory. When the configuration information is stored in the memory 120, the part of the memory 112 containing the software 116 and the configuration file 118 is erased. The part containing the loader is not erased. However, in an alternative embodiment the loader may be loaded into the working memory 120 and be executed from there. Then, in this alternative embodiment, the whole memory 112 may be erased. After erasing (part of) the memory 112, the loader selects the new software from the software update stream and stores it in the memory 112. When this is completed, the loader activates the write component of the conversion module 122. The conversion module 122 then reads the configuration data stored in the space 124 and writes it to a file 128 in the memory 112. This may be at the same location as the file 118 but also at another location. Furthermore, the information may be stored in a different number of new configuration files if that is more convenient to the new software. An advantage of storing the configuration information at another location is that wear of memory cells can be more evenly spread in the memory. Configuration information may involve parameters that are often changed, for example, the current settings of a television for sound level and channel number are stored and saved when the television is switched off in order to restore these settings when the television is switched on again.

The above process of converting the configuration information has two distinct phases: a read phase from the configuration file used by the present version of the software and a write phase to a file to be used by the updated software. The separation in two distinct phases allows that the configuration file or files for the updated software is in a different file system than the configuration file of the current software. Indeed, in the embodiment of the invention the updated software uses a different file system than the original software and, therefore, the configuration files of the updated software are stored in a file system different from the original file system.

Alternative to the above procedure, where the software update is downloaded to the device via cable or satellite signals, the update may be distributed via a physical carrier. The physical carrier, like a CDROM 126, is provided with the software update and the conversion module and optionally the conversion instruction. The physical carrier is read by a suitable reader (not shown) attached to or incorporated in the device 102. The loader module 114 then retrieves the software and the other information from the carrier instead of from the software update stream in the signals 103. The process of converting the configuration information and installing the software is the same as described above.

FIG. 2 shows an overview of the conversion of the configuration information according to the invention. The conversion module according to the invention has a read component 202 and a write component 204. The read component 202 reads the configuration information used by the current version of the software from the data store 206. In the present embodiment, the data store 206 is implemented as a number of files located in the EEPROM of the set-top box. However, this data store 206 may be implemented in another way, for example, as a single file or as fragmented pieces between the code of the software. The read component 202 converts the configuration information read from the data store 206 and stores the converted information in the data store 208. In the present embodiment, the data store 208 is implemented as a storage space in the RAM. However, this data store 208 may be implemented in another way, for example on a background memory such as a hard disk or in a part of the ROM that is not erased. After the software update has been installed on the set-top box as described above, the write component 204 reads the converted configuration from the data store 208 and writes it to the data store 210. In the present embodiment, the data store 210 is implemented as a number of files located in the EEPROM of the set-top box. However, this data store 210 may be implemented in another way, for example as a single file.

In the decomposition of the conversion module into the read component and the write component, the task of actually converting the configuration information from a structure and format according to the current software to a structure and format according to the updated software has been allocated to the read component 202. This means that the format and structure of the data store 208 are the same as the format and structure of the data store 210. Therefore, the process of the write component 204 comes down to straightforward copying of the data from the temporary data store 208 to the permanent data store 210. As an alternative, however, the task of actually converting the configuration information may be allocated to the write component 204. In that alternative, the format of data store 208 is the same as the format of data store 206 since the conversion has yet to take place.

FIG. 3 shows the conversion of the configuration information according to the invention in more detail. The conversion is executed according to a conversion script This conversion script is retrieved from the software update stream and stored in the data store 302. An alternative is that the conversion script is embedded in the coding of the conversion module itself. The read component 202 is composed of a read data sub-component 304 and a convert data sub-component 306. The read data sub-component 304 reads the data from the data store 206. Part of the data is directly stored in the data store 208 and part of the data is converted by the convert data sub-component 306. Reading the data and converting and storing the data is done according to the script stored in the data store 302. This script specifies the location of the configuration data according to the current software and specifies where and how the data must be stored according to the updated software. An example script is given below.

/* e-4TV file: Resident Global Settings */
const tNecAttr rgs[] = {

/* RGS-13 Screen format */
{ 38, 2, NEC_OTVF_BATE_GLOBAL_DATA, 1, 0, 4, 0, NULL},
/* RGS-39 Pin code mode */
{592, 1, NEC_OTVF_BATE_GLOBAL_DATA, 1, 0, 89, 0, NULL},
/* RGS-4 Remodulator frequency */
{ 6, 4, NEC_OTVF_BATE_GLOBAL_DATA, 1, 0, 106, 0, *NecfreqToChannel},
/* RGS-33 Service telephone number */
{167, 30, NEC_OTVF_CAS_KEYSETS, 3, 30, 115, 92, NULL},

This example script specifies how configuration information in the file named “Resident Global Setting” is to be read and converted. In this example, the current version of the software is referred to as the e-4TV software and the updated version of the software is referred to as the OpenTV software. For each configuration parameter the script contains a line specifying its location in the current file and how it is to be stored in the configuration files of the updated software. The specification line contains the following items: the first item indicates the offset (position) of the parameter in the current file; the second item indicates the size in bytes of the parameter; the third item gives the name of the configuration file in which the parameter is to be stored in the new version; the fourth item indicates the number of sub-parameters forming part of the configuration parameter; the fifth item indicates how far apart the sub-parameters are in the original file; the sixth item indicates the offset in the new configuration file; the seventh item indicates how far apart sub-parameters are to be stored in the new file (if applicable), and the eighth item indicates the function to be used if the value of the parameter is to be converted.

Let us now consider the parameters given in the example. The parameter at offset 38 (“Screen format”) of the e-4TV file Resident Global Settings consists of 2 bytes and must be stored in the OpenTV file BATE Global Data at offset 4. This parameter is internally identified as RGS-13. Similarly, the parameter RGS-39 (“Pin code mode”) is at offset 592 and must be stored in OpenTV file BATE Global Data at offset 89. The parameter at offset 6 (“Remodulator frequency”) must be converted before storage. The function NecfreqToChannel() is called for this purpose. Parameter RGS-33 (“Service telephone number”) must be copied three times. They are at offsets 167, 197 and 227 in this e-4TV file. So starting at offset 167, they are spaced 30 bytes apart. The parameter must, therefore, be retrieved three times and stored in the OpenTV file CAS Keysets at offsets 115, 207, 299, that is, 92 bytes apart. No conversion is necessary.

Turning again to FIG. 3, it is shown that the write component 204 of the conversion module is composed of a set defaults sub-component 308 and a write sub-component 310. The set defaults sub-component 308 sets a default value for those parameters in the data store 208 for which that is required. The setting of defaults is specified in the script in the data store 302. An example script for setting defaults is given below.

/* BATE Global Data */
static const tNecDef bgd[] = {

| | |
|---|---|
| {110, 4, 0, NULL}, | /* Current theme */ |
| { 26, 21, ‘2’, NecSetListName}, | /* List name 2 */ |
| {120, 1, 1, NULL}, | /* Virgin mode */ |

};

This example contains the defaults for OpenTV file Bate Global Data. The default for “current theme” is to be stored at offset 110. It is 4 bytes long and must be filled with zeros. The parameter “List name” is stored at offset 26 and occupies 21 bytes. The default value is ‘2’ and the function NecSetListName() takes care of creating a string (“ - - - 2”) and padding it with zeros. The virgin bit is also set by default. This is a precautionary measure so that if anything goes wrong, the set-top box restarts in the virgin mode. The virgin bit is reset at the end of the execution of the write component, so after successful completion of the conversion process. When all defaults have been set, the write sub-component 310 reads the configuration parameters from the data store 208 and stores them in the permanent files in the data store 210.

It is to be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

1. A method of updating software (116) by replacing an original part of the software (116) by an updated part, the software being arranged to operate at least partly under the control of configuration information (118), the method comprising:
reading (304) the configuration information,
converting (306) the configuration information,
storing (310) the converted configuration information, and
storing (114) the updated part.

2. A method as claimed in claim 1, wherein converting the configuration information comprises converting an original set (206) with original configuration parameters into an updated set (210) with updated configuration parameters.

3. A method as claimed in claim 2, wherein converting the original set (206) with the original configuration parameters into the updated set (210) with the updated configuration parameters uses different ones of the following operations:
copying one of the original configuration parameters into the updated set,
deleting one of the original configuration parameters from the original set,
converting one of the original configuration parameters of the original set into one of the updated configuration parameters of the updated set,
adding a new configuration parameter as one of the updated configuration parameters of the updated set.

4. A method as claimed in claim 3, wherein a conversion function is used for converting the one of the original configuration parameters of the original set (206) into the one of the updated configuration parameters of the updated set (210).

5. A method as claimed in claim 2, wherein the original set (206) is located in a first file (118) accessible by the original part (116) of the software and the updated set (210) is located in a second file (128) accessible by the updated part.

6. A method as claimed in claim 2, wherein converting the original set (206) with the original configuration parameters into the updated set (210) with the updated configuration parameters is carried out on the basis of a conversion instruction (302) specifying how the original set is to be converted into the updated set.

7. A method as claimed in claim 6, wherein the conversion instruction is a table.

8. A method as claimed in claim 1, wherein the software (116) resides in a device (102) and wherein the updated part of the software is downloaded from a remote location (106) to the device.

9. A method as claimed in claim 8, wherein converting the configuration information comprises converting an original set (206) with original configuration parameters into an updated set (210) with updated configuration parameters on the basis of a conversion instruction (302) and wherein the conversion instruction is downloaded from the remote location (106) to the device.

10. A computer program product (202, 204) that is arranged to make a processor execute the method as claimed in any of the claims 1 to 9.

11. A carrier (126) comprising the computer program product (202, 204) as claimed in claim 10.

12. A signal (103) representing the computer program product (202, 204) as claimed in claim 10.

13. A device (102) comprising software (116) and updating means for updating the software by replacing an original part of the software by an updated part, the software being arranged to operate at least partly under the control of configuration information (118) and the updating means comprising:
read means (122) for reading the configuration information,
conversion means (202) for converting the configuration information,
first storage means (204) for storing the converted configuration information, and
second storage means (114) for storing the updated part.
